(19) United States
(12) Patent Application Publication
(10) Pub. No.: US 2005/0215144 A1
(43) Pub. Date: Sep. 29, 2005

(54) Acid washed nonwoven fabric

(75) Inventor: Diane Buske Ellis, Cary, NC (US)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 10/650,584

(22) Filed: Aug. 28, 2003

Related U.S. Application Data
(60) Provisional application No. 60/408,765, filed on Sep. 6, 2002.

(51) Int. Cl. B32B 5/02; B32B 3/00; B32B 9/00

(52) U.S. Cl. 442/59; 442/408; 442/416; 28/104; 8/115.51; 8/115.7

(57) ABSTRACT

The present invention relates to a low sodium, low linting, and low streaking hydroentangled nonwoven fabric formed from a synthetic fiber and a cellulosic fiber, which may be utilized as a wipe. The fabric is free any surfactants that may have a negative impact on the sodium ion particulate count. Further, the fabric is exposed to an acid wash that extracts a vast majority of the sodium ions. The resultant hydroentangled nonwoven fabric not only exhibits excellent drape, hand, strength and absorbency, it also low linting, low streaking, and exhibits a low sodium ion count, particularly suitable for use in consumer wipe applications.

### TECHNICAL FIELD

The present invention relates generally to hydroentangled (spunlaced) nonwoven fabrics, and more particularly to low sodium, low linting, and low streaking hydroentangled nonwoven fabric comprised of synthetic and cellulosic fiber, which may be utilized as a wipe. The resultant fabric exhibits excellent drape, hand, strength and absorbency, and is particularly suited for use in consumer wipe applications, including wipe applications for the electronic industry.

### BACKGROUND OF THE INVENTION

Nonwoven fabrics have found widespread application by virtue of the versatility afforded by the manner in which the physical characteristics of such fabrics can be selectively engineered. Formation of nonwoven fabrics by hydroentanglement (spunlacing) is particularly advantageous in that the fibers or filaments from which the fabric is formed can be efficiently integrated and oriented as may be desired for a specific application. The general use of hydroentangled nonwoven fabrics as a cleaning and/or cleansing articles are well known in the art. Wipes comprising blends of different types of fibers can be readily combined by hydroentanglement so that resultant fabrics exhibiting selected physical properties can be fabricated,

Hydroentangled nonwoven fabrics are known to be relatively low tinting making them suitable for clean room wipes and those wipes utilized in the electronics industry. The amount of lint a wipe leaves behind can have a deleterious effect on electronic devices. Lint particulates have the potential to become electrically charged, in which case the lint may cause malfunctions to occur within an electronic device. In addition to the low linting, wipes utilized by the electronics industry preferably exhibit of a low sodium ion concentration.

In order to impart a desired performance into wipes utilized within the electronic industry, additives, such as a surfactant, can be utilized either internally or topically. Surfactants, such as sodium diocytl sulfosuccinate, are often used so as to enhance the hydrophilicity of a wipe. However, it is known that surfactants comprising high sodium concentrations may be problematic for wipes utilized in the electronic industry. For wiping applications in the electronics industry it is often desirable for the wipe to have a low sodium ion particle count. Sodium ions are known to be relatively large in size and also tend to have a deleterious effect on the electrical properties of electronic devices, often rendering the devices defective.

Nonwoven fabrics have been used in the past for the purpose of electronic industry wipes, such as described in U.S. Pat. No. 4,328,279 to Meitner, et al., hereby incorporated by reference. This concept utilizes a sodium dioctyl sulfosuccinate and a nonionic surfactant so as to increase the wettability of the fabric, however, such a surfactant has a deleterious effect on the fabric's sodium ion particulate count.

A need remains for a low linting, low sodium ion particle count nonwoven wipe suitable for use in the electronics industry wherein the nonwoven fabric is soft, absorbent, durable and is comprised of a sodium ion particle count of less than 45 ppm.

### SUMMARY OF THE INVENTION

The present invention relates to a low sodium, low tinting, and low streaking hydroentangled nonwoven fabric formed from a synthetic fiber and a cellulosic fiber, which may be utilized as a wipe. The fabric is free any surfactants that may have a negative impact on the sodium ion particulate count. Further, the fabric is exposed to an acid wash that extracts a vast majority of the sodium ions. The resultant hydroentangled nonwoven fabric not only exhibits excellent drape, hand, strength and absorbency, it also low linting, low streaking, and exhibits a low sodium ion count, particularly suitable for use in consumer wipe applications.

The low sodium nonwoven wiper is comprised of hydroentangled pulp and fiber. The mechanism of nonwoven fabric manufacture by hydroentanglement is well known to those skilled in the art, and is generally in accordance with the teachings of Evans, U.S. Pat. No. 3,485,706, herein incorporated by reference. The hydroentangled pulp and fiber nonwoven fabric has a total sodium ion particle count of less than 45 ppm, and more preferably, a sodium ion particle count of less than 25 ppm. Further, the hydroentangled fabric is low linting rendering it suitable for wiping applications in the electronic industry, as well as clean room wipes.

The low sodium wiper fabric is free of binders that may leave behind undesirable residues on surfaces upon wiping. The low sodium content is attributed to an acetic acid and de-ionized water wash used subsequent to the hydroentanglement process, which is pulled through the web by mechanical means, such as a vacuum. As a result, a vast majority of the sodium ion particles are removed from the fabric. The removal of the sodium ions also improves the hand of the resultant nonwoven fabric.

Other features and advantages of the present invention will become readily apparent from the following detailed description, the accompanying drawings, and the appended claims.

### BRIEF DESCRIPTION OF THE DRAWINGS

FIG. 1 is a diagrammatic view of an apparatus for manufacturing a nonwoven fabric, embodying the principles of the present invention.

### DETAILED DESCRIPTION

While the present invention is susceptible of embodiment in various forms, there is shown in the drawing, and will hereinafter be described, a presently preferred embodiment, with the understanding that the present disclosure is to be considered as an exemplification of the invention, and is not intended to limit the invention to the specific embodiment illustrated.

The fibers utilized in the present invention include those of both synthetic and natural composition, of a finite staple length or natural fiber length. Synthetic fibers include those selected from thermoset polymers, thermoplastic polymers, and the combinations thereof. Representative thermoplastic fibers include polyamides, polyesters, and polyolefins. Natural fibers include those that are of cellulosic composition, such as wood pulp, cotton, and rayons. These fibers may optionally be applied to, or otherwise, incorporate one or more layers of the same or different composition, including other staple fiber blends. Further, the fibers and fiber layers may be combined with one or more layers of continuous filaments, micro-denier filaments or fibers, and barrier or breathable films.

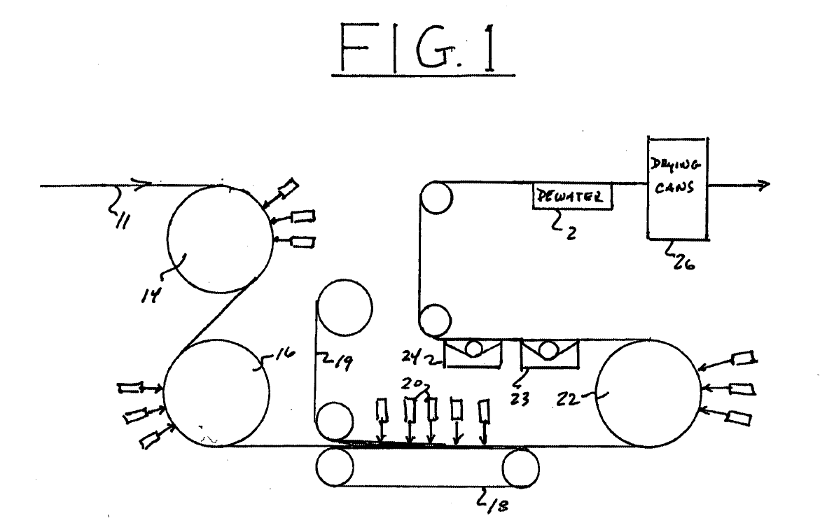

With reference to FIG. 1, therein is diagrammatically illustrated an apparatus for practicing the method of making a low sodium, low linting, and low streaking nonwoven fabric embodying the principles of the present invention. The present nonwoven fabric is preferably formed from juxtaposed synthetic fiber and cellulosic fiber webs, which are subjected to hydroentanglement by direction of high-pressure liquid streams thereagainst, preferably first against one expansive surface of the juxtaposed webs and thereafter against the opposite expansive surface of the webs.

It is within the purview of the present invention that each of the synthetic fiber and celluosic fiber webs may be provided in the form of more than one web, thereby permitting the integration of different types of synthetic fibers, and/or different types of cellulosic fibers. It is also within the purview of the present invention that each of the synthetic fiber and cellulosic fibers webs may be comprised of a homogenous component composition within the web, or in the alternative, comprised of a blend of differing component compositions.

In the presently preferred practice, the synthetic fibers are provided in the form of staple length polyester fibers, while the cellulosic fibers are provided in the form of wood pulp fibers introduced in the form of a wetlaid web, commonly referred to as “tissue”, subsequently integrated by hydroentanglement with the synthetic fiber web. Notably, the present invention contemplates that the synthetic fiber web 11 is subjected to hydroentanglement at drums 14 and 16 to form a partially entangled web prior to hydroentanglement of the cellulosic fiber web therewith.

At this stage of the process, a cellulosic fiber web 19 is juxtaposed with the partially entangled synthetic fiber web for formation of the present composite nonwoven fabric. The cellulosic fiber web is preferably provided in the form of a wetlaid web, but it is within the purview of the present invention to provide the cellulosic fibrous material in other forms. The juxtaposed synthetic fiber and cellulosic fiber webs are subjected to hydroentanglement under the influence of high-pressure liquid streams generated by suitable manifolds at 20 positioned above the entangling belt 18.

In accordance with the preferred practice of the present invention, the high-pressure liquid streams from manifold 20 are directed against a first expansive surface of the juxtaposed webs. Thereafter, the webs are directed about another entangling drum 22, with the liquid streams directed against the opposite expansive surface of the webs. The webs may optionally be further directed over a three-dimensional transfer device, wherein the integrated webs could be imparted with a three-dimensional image due to further hydroentanglement. Subsequent to hydroentanglement, the now integrated webs are exposed to an acetic acid wash at 23 and then rinsed of the wash at 24 to facilitate the removal of sodium ions from the webs. Thereafter, the integrated webs can be transferred over a dewatering slot 25, and then dried at 26 and wound for storage and shipment.

The acetic acid wash, comprised of de-ionized water, reacts with the entangled nonwoven fabric so as to remove a majority of the sodium ions once the wash is extracted via rinsing and dewaterinig, resulting in a wipe that has a sodium ion particle count less than 25 ppm. It has been found that the acetic acid wash not only extracts an excess amount of sodium ions, but also leaves the resultant fabric unexpectedly softer.

The nonwoven fabric embodying the principles of the present invention is highly versatile in its end-use wiping applications. The wipe may either be dry, or used in conjunction with a cleaning agent or lotion. Resulting low-streaking and low-linting attributes makes the nonwoven fabric suitable for household, automotive, and industrial glass cleaning wipes, as well as suitable for clean-room wipes where low-linting attributes are essential, Also, the low-linting wipe comprised of a low sodium ion particle count makes the nonwoven wipe suitable for electronic applications. The nonwoven wiper is soft and durable, in addition, to the low linting, low sodium, and low streaking characteristics. It conforms well to any cleanable surface and is nonabrasive so as not to have a deleterious affect on surfaces that are easily abraded, such as leather, metal, and wood.

Tables 1 and 2 include the test results for the nonwoven fabric of the present invention. The fabric was tested for sodium ion particle count, absorbency time and capacity (ASTM D 1117-95), degree of softness, and lint particle counts, by the biaxial shake (IST 160.2-95) test method. The sodium ion count was determined by weighing a sample, submerging the sample in a standard acid extraction reagent, and analyzing a diluted aliquot of the extract with an atomic absorption flame spectrophotometer. The test results indicate that the nonwoven fabric is suitable for a wide variety of consumer wipe applications.

From the foregoing, numerous modifications and variations can be effected without departing from the true spirit and scope of the novel concept of the present invention. It is to be understood that no limitation with respect to the specific embodiment disclosed herein is intended or should be inferred. The disclosure is intended to cover, by the appended claims, all such modifications as fall within the scope of the claims.

TABLE 1

| Test Methods | Units | |
|---|---|---|
| Weight | (osy) | 1.9 |
| Absorbency Capacity | (g/g) | 651 |
| Absorbency Time | (sec) | 1.9 |
| Bulk | (in) | 0.1 |
| MD Softness | (g) | 31.7 |
| CD Softness | (g) | 7.7 |
| Sodium Ion Count | (ppm) | 13.3 |

TABLE 2

| Test Method | Units | |
|---|---|---|
| Weight | (osy) | 1.8 |
| Particles | (biaxial shake) (×103/cm3) | 18 |

1. A method of making a nonwoven fabric comprised of a sodium ion count of less than 45 ppm comprising the steps of:
a. providing a first layer comprising staple length polymeric fibers;
b. providing a second layer comprising natural fiber;
c. juxtaposing the second layer upon the first layer; and
d. applying a hydraulic energy to said juxtaposed layers through a plurality of hydraulic manifolds to form a nonwoven fabric;
e. applying an acid wash to said nonwoven fabric;
f. rinsing said nonwoven fabric; and
g. drying said nonwoven fabric.

2. A method of making a nonwoven fabric comprised of a sodium ion count of less than 45 ppm as in claim 1, wherein said polymeric fibers are selected from the group consisting of thermoset and thermoplastic fibers.

3. A method of making a nonwoven fabric comprised of a sodium ion count of less than 45 ppm as in claim 2, wherein said thermoplastic fibers are selected from the group consisting of polyamides, polyesters, polyolefins, and the combinations thereof.

4. A method of making a nonwoven fabric comprised of a sodium ion count of less than 45 ppm as in claim 1, wherein said natural fibers are selected from the group consisting of wood pulp, cotton, rayon, and the combinations thereof.

5. A method of making a nonwoven fabric comprised of a sodium ion count of less than 45 ppm as in claim 1, wherein said acid wash is comprised of acetic acid and de-ionized water.

6. A wipe comprised of a sodium ion particle count of less than 45 ppm wherein said wipe is comprised of hydroentangled synthetic fiber and wood pulp and subsequently exposed to an acetic acid and de-ionized water wash said wipe being suitable for household, medical, industrial, and electronic applications.
